(19) United States
(12) Patent Application Publication
(10) Pub. No.: US 2015/0294249 A1
(43) Pub. Date: Oct. 15, 2015

(54) RISK PREDICTION FOR SERVICE CONTRACTS VASED ON CO-OCCURENCE CLUSTERS

(71) Applicant: INTERNATIONAL BUSINESS MACHINES CORPORATION, Armonk, NY (US)

(72) Inventors: SINEM GUVEN KAYA, Yorktown Heights, NY (US); VUGRANAM C. SREEDHAR, YORKTOWN HEIGHTS, NY (US); MATHIAS B. STEINER, YORKTOWN HEIGHTS, NY (US); SHERIF A. GOMA, YORKTOWN HEIGHTS, NY (US)

(21) Appl. No.: 14/250,693

(22) Filed: Apr. 11, 2014

(51) Int. Cl. G06Q 10/06

(52) U.S. Cl. CPC G06Q 10/0635

(57) ABSTRACT

A method for predicting risks for information technology service contracts includes calculating a probability of occurrence of each target risk in a target contract; constructing clusters of root causes observed in historical contracts similar to the target contract, for each of the clusters, identifying root causes that co-occur with target contract risks by searching each cluster for root causes of similar historical contract risks such that the identified root causes represent additional new contract risks, and calculating the probability of occurrence of each new target risk identified for the target contract based on root causes identified in the similar historical contract risks. Two root causes are in the same cluster if both root causes occur in one or more contracts in the set of historical contracts, where two root causes co-occur if both root causes are in the same cluster.

### BACKGROUND

1. Technical Field

Embodiments of the present disclosure are directed to predicting the potential risks of a new opportunity in terms of the observed root causes of similar historical contracts.

2. Discussion of the Related Art

Information technology (IT) service contract risk prediction is a major challenge facing IT service providers today. Service providers need to know about the potential risks for a given new opportunity ahead of contract signing to make educated decisions about whether to undertake the IT operations of a potential client, how to be proactive about mitigation planning if they are willing to take on a risky opportunity, and to price the contract accordingly to cover for risks that cannot be mitigated.

Existing risk management processes have limitations. Service providers often need to decide on whether to undertake a contract with limited access to the client's IT environment and without thoroughly understanding potential risks. In addition, there is lack of a quantitative approach to objectively evaluate risks and prioritize risk management tasks.

It is, therefore, useful to have reliable risk prediction algorithms that can take into account the performance of similar historical contracts to expose all relevant potential risks in a systematic manner.

### SUMMARY

According to an embodiment of the disclosure, there is provided method for predicting risks for information technology (IT) service contracts, including calculating a probability of occurrence of each of one or more target risks in a target contract, constructing one or more clusters of root causes observed in historical contracts similar to the target contract, where two root causes are in the same cluster if both root causes occur in one or more contracts in the set of historical contracts, where two root causes co-occur if both root causes are in the same cluster, for each of the one or more clusters, identifying root causes that co-occur with one or more target contract risks by searching each cluster for root causes of similar historical contract risks such that the identified root causes represent additional new contract risks, and calculating the probability of occurrence of each new target risk identified for the target contract based on root causes identified in the similar historical contract risks.

According to a further embodiment of the disclosure, calculating a probability of occurrence of each of the one or more target risks in the target contract includes calculating a similarity between the target contract and each historical contract, and for each historical contract whose similarity with the target contract is above a similarity threshold, and for each risk associated with the target contract, summing the similarity for each historical contract in which the risk occurs, and dividing by a sum of the similarities of all historical contracts in the set of similar historical contracts.

According to a further embodiment of the disclosure, constructing one or more clusters of root causes of the one or more target contract risks includes constructing a graph of the root causes for the one or more target contract risks, and forming root cause co-occurrence clusters from the graph. Two root causes are connected by an edge if the two root causes frequently co-occur in the set of similar historical contracts, the two root causes are defined to frequently co-occur if each of the two root causes occurs for a same subset of the set of similar historical contracts, and a size of the subset with respect to the size of the set of similar historical contracts is greater than a predetermined threshold,

According to a further embodiment of the disclosure, forming root cause co-occurrence clusters from the graph includes computing a Laplacian matrix L∈ [symbol] ^{n×n} of the graph, where n is a number of root causes, computing a first k eigenvalues of the Laplacian matrix, where k<n, computing a reduced dimensional matrix T∈ [symbol] ^{n×k} from the predetermined number of eigenvalues clustering points (yᵢ), i=1, . . . , n, that correspond to rows of the reduced dimensional matrix into k clusters Cᵢ, and generating co-occurrence clusters Sᵢ, i=1, . . . , k, from the point clusters where Sᵢ={j|yⱼ∈Cᵢ}.

According to a further embodiment of the disclosure, the method includes using a k-means algorithm to cluster points (yᵢ), i=1, . . . , n, into k clusters Cᵢ.

According to a further embodiment of the disclosure, calculating the probability of occurrence of each new target risk includes calculating a weighted average of a number of occurrences of each new target risk across historical contracts whose similarity may or may not exceed the similarity threshold, where a weight is determined by the contract similarity.

According to a further embodiment of the disclosure, the method includes adjusting the probability of occurrence of each target risk identified for the target contract based on additional root causes identified through co-occurrence clusters in the similar historical contract risks by adding an adjustment weight to the occurrence probability.

According to a further embodiment of the disclosure, the adjustment weight for each target risk based on root causes identified through co-occurrence clusters in the similar historical contract risks is calculated based on business logic.

According to a further embodiment of the disclosure, the adjustment weight for each target risk based on root causes identified though co-occurrence clusters in the similar historical contract risks is calculated by multiplying the occurrence probabilities of each target risk in a chain of target risks, where each successive target risk in the chain is dependent upon a preceding target risk in the chain.

According to a further embodiment of the disclosure, the method includes predicting a set of risks that impact profitability of a new services contract from the one or more target risks in the target contract and the new target risk identified in the similar historical contract risks, and predicting an the overall aggregated risk impact on contract profitability in terms of an achieved gross profit percentage compared to a planned gross profit percentage.

According to a further embodiment of the disclosure, the method includes eliminating target risks before contract signing.

According to a further embodiment of the disclosure, the method includes predicting other co-occurring risks based on risks observed during a post contract-signature delivery phase.

According to another embodiment of the disclosure, there is provided a non-transitory program storage device readable by a computer, tangibly embodying a program of instructions executed by the computer to perform the method steps for predicting risks for information technology (IT) service contracts.

### BRIEF DESCRIPTION OF THE SEVERAL VIEWS OF THE DRAWINGS

FIGS. 1(a)-(d) illustrate several kinds of clusters around observed root causes, according to an embodiment of the disclosure.

FIG. 2 illustrates a co-existence cluster according to an embodiment of the disclosure.

FIG. 3 is a flowchart of a method for forming root cause co-occurrence clusters, according to an embodiment of the disclosure.

FIG. 4 illustrates how contract similarity can be used to provide predictions for a new opportunity, according to an embodiment of the disclosure.

FIG. 5 is pseudocode of a risk prediction algorithm, according to an embodiment of the disclosure.

FIG. 6 is pseudocode of a risk prediction algorithm that includes co-occurrence, according to an embodiment of the disclosure.

FIG. 7 illustrates predictions for a new opportunity, before and after using a root cause temporal cluster, according to an embodiment of the disclosure.

FIG. 8 illustrates observed root causes for a contract in delivery, and the predicted risks for that contract after using a root cause dependency cluster, according to an embodiment of the disclosure.

FIG. 9 is a block diagram of an exemplary computer system for implementing a method for predicting risks of troubled contracts, according to an embodiment of the disclosure.

### DETAILED DESCRIPTION

Exemplary embodiments of the invention as described herein generally include systems and methods for predicting risks of troubled contracts in terms of the observed root causes of similar historical contracts. Accordingly, while embodiments of the invention are susceptible to various modifications and alternative forms, specific embodiments thereof are shown by way of example in the drawings and will herein be described in detail. It should be understood, however, that there is no intent to limit embodiments of the invention to the particular forms disclosed, but on the contrary, embodiments of the invention cover all modifications, equivalents, and alternatives falling within the spirit and scope of the disclosure.

Embodiments of the present disclosure focus on predicting the potential risks of a new opportunity in terms of the observed root causes of similar historical contracts by using co-occurrence algorithms. While there is several previous work on risk management of information technology (IT) contracts, they are either specific to the post-contract signature phase or do not focus on risk prediction in terms of the root causes observed in similar historical contracts. Although financial risk analytics (FRA), disclosed in “Financial Risk Analytics for Service Contracts”, U.S. application Ser. No. 13/685,362, filed on Nov. 26, 2012, the contents of which are herein incorporated by reference in their entirety, does perform risk prediction in terms of the root causes observed in similar historical contracts, the underlying algorithms do not leverage co-occurrence. Algorithms according to embodiments of the present disclosure extend the FRA algorithms.

Methods according to embodiments of the disclosure for risk prediction rely on co-occurrence algorithms. According to embodiments of the disclosure, co-occurrence can be used for risk prediction as follows.
1. Detect clusters of root causes. It is possible to build several different kinds of clusters around root causes, such as temporal (root cause A occurs after root cause B), dependency (root cause C leads to root causes D, E, and F), etc.
2. Improve accuracy of risk prediction based on contract similarity and co-occurrence clusters.

The risks of a given new opportunity can be predicted by keeping track of the observed root causes and their frequency in similar historical contracts. While this method does provide a way to predict risks for a given new opportunity, it does not leverage the inter-relationships or dependencies of root cases. Embodiments of the disclosure can use root cause co-occurrence clusters in a pre-contract signature (engagement) phase to strengthen the contract similarity-based prediction by identifying additional potential risks that may be missed by a contract similarity model. Embodiments of the disclosure can also use root cause co-occurrence clusters in a post-contract signature (delivery) phase to predict likely risks in terms of observed root causes for a service contract for pro-active mitigation given the materialization of root causes residing in the co-occurrence clusters. Delivery risks result from activities after contract signing or after projects start, such as a failure to meet targeted Service Line Agreements (SLAs), a project manager leaving in the middle of project, whereas engagement risks result from activities before contract, such as, under-estimating the number of resources needed to complete a project during the contract design phase, not allocating enough time to complete a project, etc.

### Detect Clusters of Root Causes

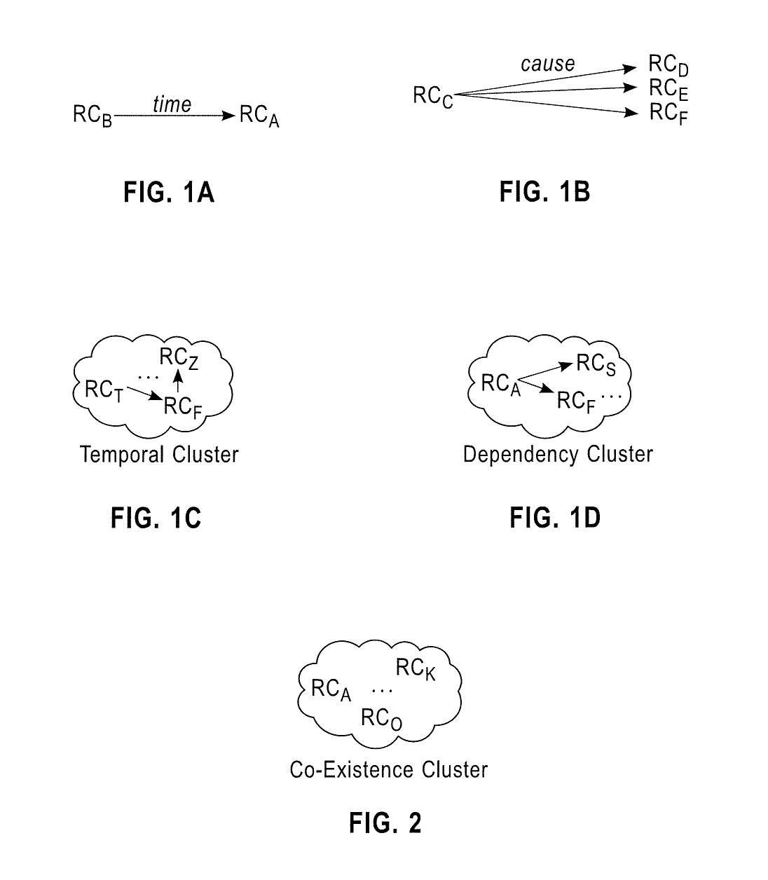

As disclosed above, according to embodiments of the disclosure, it is possible to build several different kinds of clusters around root causes, such as temporal (root cause A occurs after root cause B), shown in FIG. 1(a), dependency (root cause C leads to root causes D, E, and F), shown in FIG. 1(b), etc. A temporal cluster is shown in FIG. 1(c) and a dependency cluster is shown in FIG. 1(d).

To form a cluster according to an embodiment of the disclosure, start with a set of contracts C and a contract c in C. Let RC be the set of all possible root causes, and let RC(c) be the subset of root causes for the contract c. This relationship may be denoted symbolically as RC(c)⊂RC. Two root causes r₁, r₂∈RC are said to co-occur if r₁∈RC(c) and r₂∈RC(c) for some c∈C. A co-existence cluster is shown in FIG. 2.

Two root causes r₁ and r₂ are said to “frequently” co-occur if r₁∈RC(X) and r₂∈RC(X) for some set of contracts X∪C, and |X|/|C| is greater than some threshold, where |X| is the size of the set X, and |C| is the size of set C. Given RC and C, a co-occurrence graph CoG(V,E) can be constructed, where V is a set of root causes and E is a set of edges such that (r₁, r₂)∈E if r₁ and r₂ “frequently” co-occur. Given a co-occurrence graph CoG(V,E), there exist graph clustering algorithms that can perform clustering. Given a co-occurrence graph G, a cluster forming algorithm according to an embodiment of the disclosure can construct k clusters.

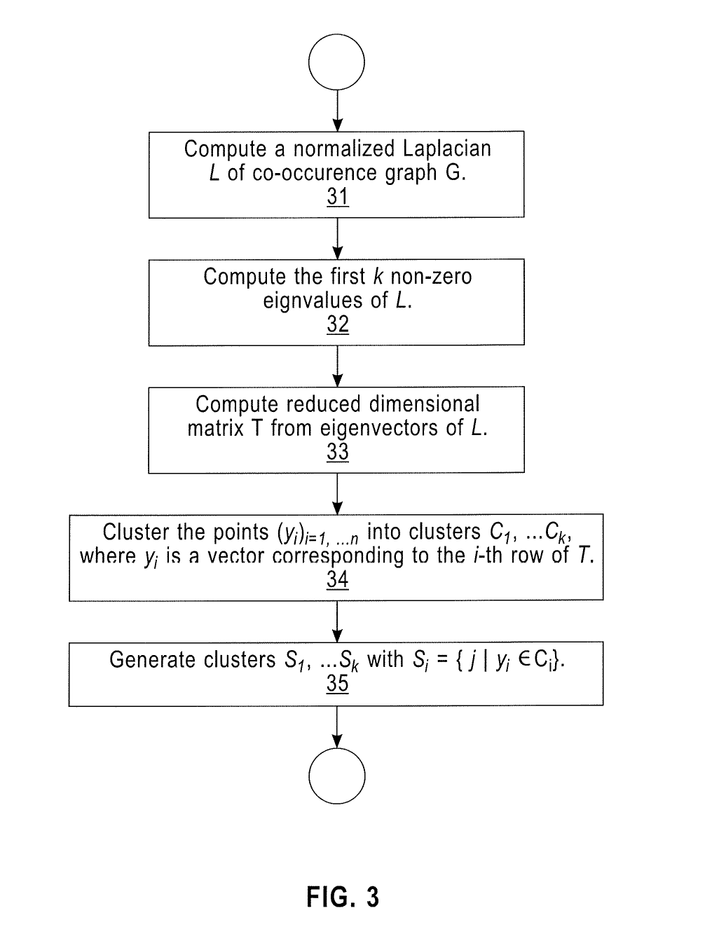

FIG. 3 is a flowchart of a method for forming root cause co-occurrence clusters, according to an embodiment of the disclosure. Referring now to FIG. 3, an algorithm begins at step 31 by computing a normalized Laplacian L∈ [symbol] ^{n×n}, where n is the number of nodes in the CoG, wherein each node corresponds to a root cause, and then computing the first k non-zero eignvalues λ₁≦λ₂≦ . . . ≦λₖ at step 32. Given a graph G(V, with root cause nodes r₁ and r₂ connected by edge (r₁, r₂), the normalized Laplacian matrix of G(V, E) may be defined as follows:

$$ℒ ( {r}_{1} , {r}_{2} ) = \{ \begin{matrix}1 - \frac{w ( {r}_{1} , {r}_{1} )}{d ( {r}_{1} )} , & if {r}_{1} = {r}_{2} and d ( {r}_{1} ) \neq 0 , \\ - \frac{w ( {r}_{1} , {r}_{2} )}{\sqrt{d ( {r}_{1} ) \times d ( {r}_{2} )}} , & if ( {r}_{1} , {r}_{2} ) ∈ E , \\ 0 & otherwise ,\end{matrix}$$

where w(r₁, r₂) is a weight of edge (r₁, r₂), and d(r₁) is a degree of each node, which is the sum of edge weights incident on node r₁. The weight of an edge (r₁, r₂) may be a measure of co-occurrence of the root causes r₁ and r₂.

Let u₁, u₂, . . . , uₖ be the corresponding eigenvectors from U with U∈ [symbol] ^{n×k}. Next, at step 33, a matrix T∈ [symbol] ^{n×k} may be constructed as follows:

$${t}_{ij} = \frac{{u}_{ij}}{\sqrt{{\sum }_{k} {u}_{ik}^{2}}} .$$

This matrix T contains reduced dimensional data upon which clustering will be performed. Then, for i=1, . . . , n, let y₁∈ [symbol] ^{k} be the vector corresponding to the i-th row of T. Next, at step 34, cluster the points (yᵢ)_{i=1, . . . , n} into clusters C₁, . . . , Cₖ. An exemplary, non-limiting algorithm for forming clusters C₁, . . . , Cₖ is a k-means algorithm. Finally, generate the clusters S₁, . . . , Sₖ with Sᵢ={j|yⱼ∈Cᵢ} at step 35.

Each cluster is a root cause co-occurrence cluster. Let D={d₁, d₂, . . . , dₙ} be a set of RC clusters. If two root causes frequently co-occur, then they belong to the same cluster. Note that D is a equivalence relation.

### Improving Accuracy of Risk Prediction

The accuracy of a risk prediction can be improved based on contract similarity and co-occurrence clusters. For a given new opportunity, for which contract risks are to be predicted in terms of historically observed root causes, one first determines a set of similar historical contracts. Contract similarity is determined by calculating a distance between each historical contract and the new opportunity using several contract fingerprints, such as geography, total contract value (TCV), risk assessment surveys, etc. Once a subset of similar historical contracts is determined, embodiments may keep track of which observed root causes from similar historical contracts occur with what frequency to determine how likely it is for a given root cause to also occur in the new opportunity.

While this method does provide one way of predicting root causes for a given new opportunity, it does not leverage the inter-relationships and/or dependencies of root causes.

According to an embodiment of the disclosure, root cause co-occurrence clusters described above may be used to strengthen the contract similarity determination by predicting additional risks that may be missed by the original determination.

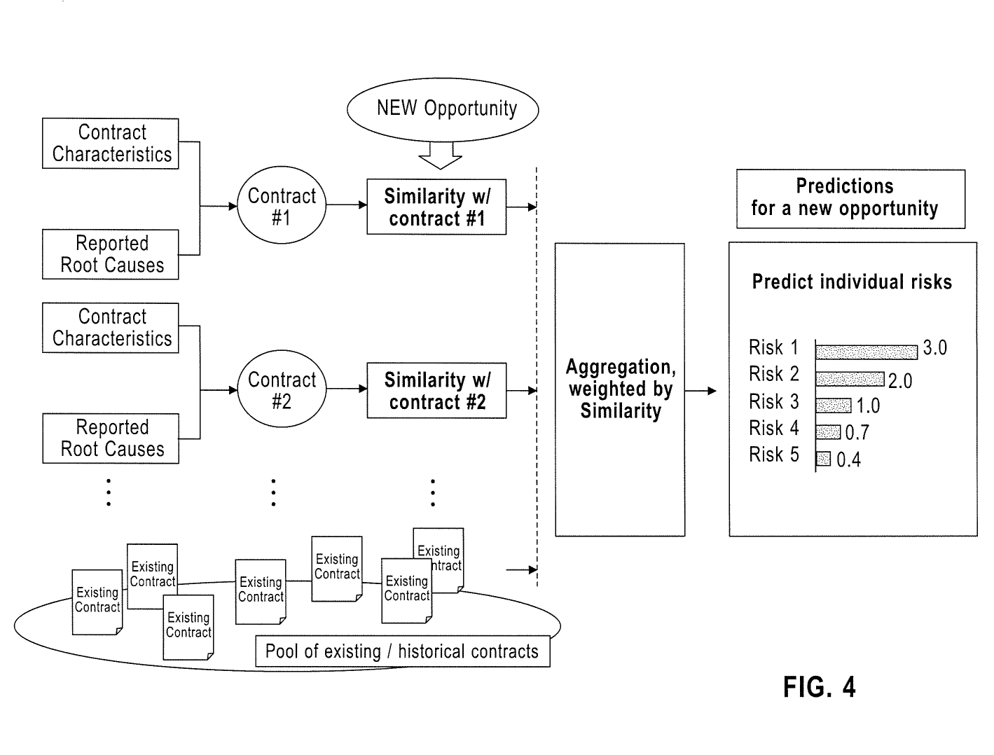

FIG. 4 illustrates how contract similarity can be used to provide predictions for a new opportunity. That is, a prediction for a given new opportunity is based on a measurement of similarity between the new opportunity and a set of historical contracts, based on their fingerprints. Referring to FIG. 4, for each contract taken from a pool of existing/historical contracts, the contract characteristics and reported root causes will be compared with corresponding features of the new opportunity, and the results of these comparisons will be aggregated, weighted by the similarity of each existing contract to the new opportunity, to yield a set of predictions. The details of contract similarity measure are disclosed in U.S. application Ser. No. 13/685,362, filed on Nov. 26, 2012, incorporated by reference above. With this definition, a predictive model according to an embodiment of the disclosure can then provide an individual risk prediction for the new opportunity.

A risk prediction method according to an embodiment of the disclosure is based on measuring a similarity between a given new opportunity and a set of historical contracts based on their fingerprints. Two contracts are similar if they have similar contract fingerprints. In a data set for testing embodiments of the invention, there are more than 300 features in a contract fingerprint, but not all features are equally important or useful for risk predictions. To ensure that more significant features provide a greater contribution to the similarity measure, higher weights are assigned to them. Since a goal of determining contract similarity is to predict risks, weights are assigned to features based on their correlation with the actual similarity between a pair of contracts, in terms of their reported root causes. The higher the correlation, the higher the weight.

Based on the weighted fingerprint, which is a vector of weighted features, one may calculate the Euclidian distance between the new opportunity and each historical contract. The contract similarity Sim(i,j) between the new opportunity i and each historical contract j can then be calculated as Sim(i, j)=1−Dist(i, j) where Dist(i, j) is the Euclidian distance between the new opportunity i and historical contract j.

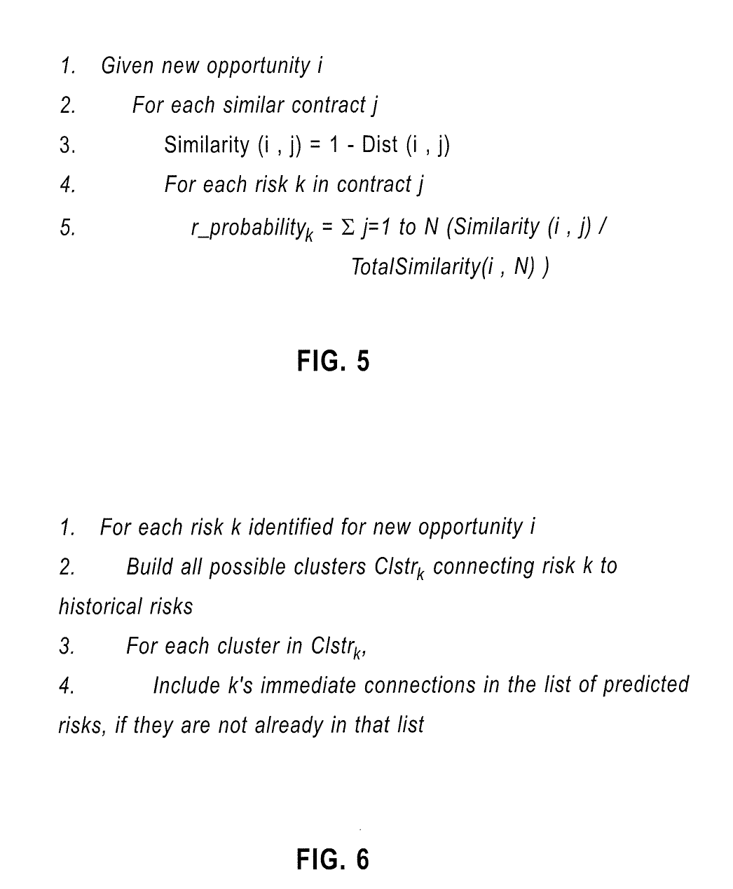

A final step is predicting risks for the new opportunity based on its similarity to historical contracts by considering how often certain root causes occurred in similar historical contracts. In other words, one may calculate the probability of a given risk occurring for the new opportunity by taking a weighted average of its number of occurrences across all similar contracts such that the weight is determined by the degree of contract similarity. A risk prediction algorithm according to an embodiment of the disclosure is illustrated in FIG. 5. Referring to the figure, the loop of statement 2 is performed only for those contracts j whose similarity is above a pre-defined threshold, so only a subset of historical contracts are used. The result calculated in statement 5 is a probability of risk k occurring in new opportunity i.

Note that the formula for r_probabilityₖ in statement 5 of the algorithm indicates that if root cause rₖ occurs in all historical contracts j, then the probability r_probabilityₖ=1. However root cause rₖ does not necessarily occur in all historical contracts, so the probability is calculated based on the historical contracts that observe this root cause rₖ.

The concept of contract similarity can ensure that risks for a new opportunity are predicted/determined based on using only very similar historical contracts' observed root causes. This means that, depending on a similarity threshold, the original model may miss some risks, which can be caught by the extended algorithm's co-occurrence component.

For example, assume a similarity threshold of 0.75, and assume there are 7 historical contracts, 4 of which are similar to the new opportunity by having a similarity measure above the threshold. Assume the following contracts (C) and their observed risks (R):

| | |
|---|---|
| C1--> R1 | (similarity of C1 with the new opportunity >= 0.75) |
| C2--> R1, R2 | (similarity of C2 with the new opportunity >= 0.75) |
| C3--> R1, R2, R3 | (similarity of C3 with the new opportunity >= 0.75) |
| C4 --> R1, R2, R3, | (similarity of C4 with the new opportunity >= 0.75) |
| R4 | |
| C5--> R3, R5 | (similarity of C5 with the new opportunity < 0.75) |
| C6-->R3, R5 | (similarity of C6 with the new opportunity < 0.75) |
| C7-->R3, R5 | (similarity of C7 with the new opportunity < 0.75) |

Since the similarity of contracts C5, C6, and C7 with the new opportunity is less than the threshold of 0.75, these contracts would not be used in the original algorithm calculation. The original algorithm would only use contracts C1 through C4 in the calculations and yield predicted risks for new opportunity as: R1, R2, R3, and R4 in that order with decreasing probability. The original algorithm would, however, miss the fact that, in less similar contracts C5 through C7, R5 always co-occurs with R3 and is therefore highly likely to happen to contracts where R3 occurs.

The extension identifies other likely risks through co-occurrence clusters, such as Risk 5, and calculates their probabilities by also considering the relatively less similar 3 historical contracts they may occur in. Those 3 historical contracts that had observed Risk 5 were not originally part of the initial risk prediction algorithm as their similarity did not meet the threshold. The extension implies that just because the historical contracts that had observed Risk 5 are not very similar to the new opportunity does not mean that Risk 5, which is observed to always follow Risk 3, which is observed in the similar contracts, will not materialize in the new opportunity.

According to further embodiments of the disclosure, the above algorithm can be extended to include a co-occurrence algorithm according to an embodiment of the disclosure as illustrated in FIG. 6, which incorporates co-occurrence. Referring now to FIG. 6, in statement 2, one or more clusters of root causes observed in historical contracts similar to the target contract are constructed. Two root causes are in the same cluster (co-occur) if both root causes occur in one or more contracts in said set of historical contracts. Note that the Build all possible clusters in statement 2 of the algorithm corresponds to a cluster building algorithm according to an embodiment of the disclosure as illustrated in FIG. 3. The clusters include the temporal, dependency, and co-existence clusters discussed above. Statements 3 and 4 identify, for each cluster, and for each new opportunity risk in each cluster, root causes that co-occur with one or more target contract risks by searching each cluster for root causes of similar historical contract risks, such that the identified root causes represent additional new contract risks.

For example, if k==RC₃, and RC₅ is in a dependency cluster of k, include RC₅ as a predicted risk, if it is not already among predicted risks, as RC₅ will tend to follow RC₃ based on historical data. The algorithm of FIG. 6, which entails the original plus co-occurrence, would thus list the original predicted risks R1 through R4 and then add risk R5 as a result of the co-occurrence extension.

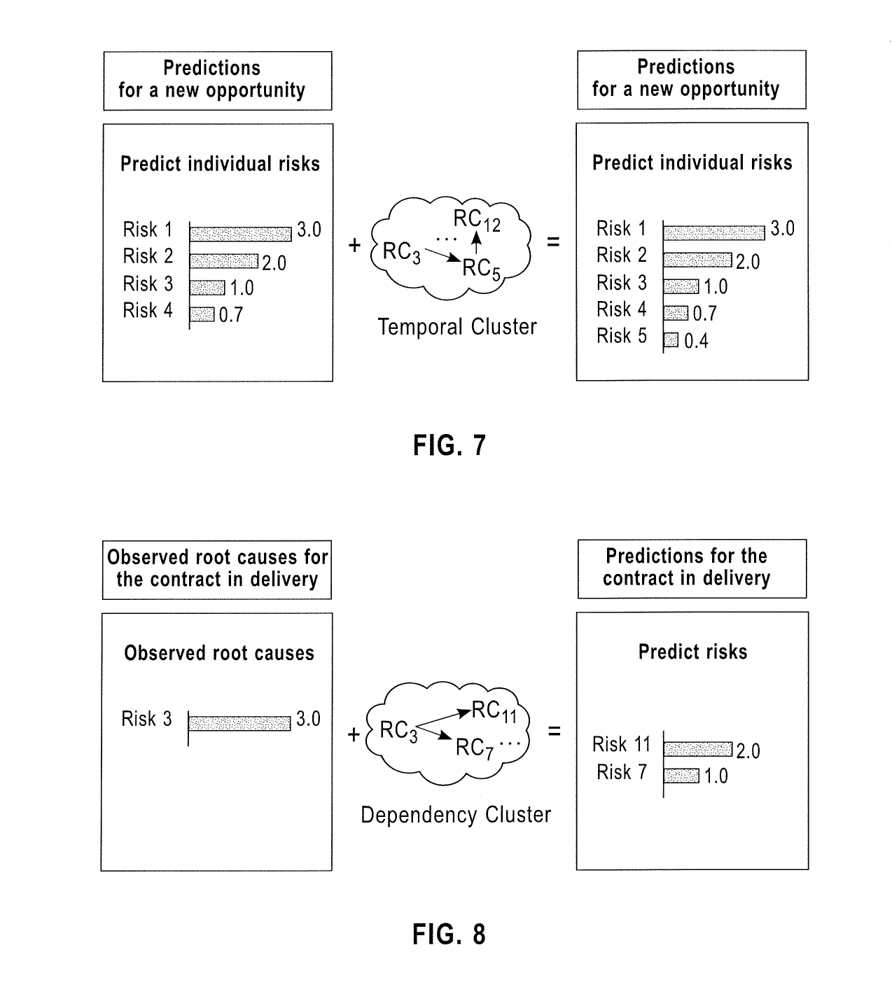

FIG. 7 illustrates predictions for a new opportunity, before and after using a root cause temporal cluster. Referring now to FIG. 7, there are originally 4 risks predicted for the new opportunity, but after combining with the temporal cluster, which indicates that r₅ occurs after r₃, there are now 5 risks predicted for the new opportunity. More formally, given a new opportunity c∈C, let RC(c)⊂RC. Let r₃∈RC(c) and r₅∉RC(c), where r₅ occurs after r₃. Now if r₃ and r₅ belong to the same RC co-occurrence cluster, one can predict that r₅ will eventually occur in contract c.

As can be seen from FIG. 7, the probabilities of the risks already identified with the original contract similarity based risk prediction algorithm, i.e., r_probabilityₖ, may, as will be further described below, be directly used by the extension, as illustrated by the presence of risks 1 through 4 and associated probabilities in both the left and right hand side lists.

The probability of any additional risk identified by the extension, such as Risk 5 in the right hand side list, may be calculated by taking a weighted average of its number of occurrences across less-similar contracts such that the weight is determined by the degree of contract similarity. Less-similar means it did not meet the similarity threshold of the algorithm, but still has a similarity value assigned to it.

Calculating the probability of the newly identified risks through the co-occurrence extension by leveraging less similar contracts has now been described. However, risks already identified through the initial similar contract algorithm may also be identified by the co-clustering. The probabilities of the risks already identified with the original algorithm may be directly used by the extension. Sometimes, those probabilities may need to be updated.

For example, if RC₃ in the above diagram had an arrow pointing to RC₄ (or Risk 4) instead of RC₅, that means Risk 4 is not only identified by the contract similarity algorithm but also through the co-occurrence extension. Therefore it should be emphasized over other risks that were identified through the similarity or extension algorithms alone. According to an embodiment of the disclosure, to address this, the probability of RC₄ occurring for new opportunity is boosted by adding an adjustment weight to the probability calculated through the contract similarity algorithm. So the final probability would be 0.7+adjustment_weight, where adjustment_weight could be defined through business logic or by multiplying the respective probabilities of RC₃×RC₄.

FIG. 8 illustrates observed risks for a new opportunity in delivery, before and after using a root cause dependency cluster. Referring now to FIG. 8, there was originally risk r₃ predicted for the new opportunity with a value of 3.0, but after combining with the dependency cluster, which indicates that risks r7 and r11 depend on r₃, risks r₇ and ᵣ₁₁ have been added, with respective values of 1.0 and 2.0. More formally, given a contract c∈C, let RC(c)⊂RC, and let r₃ be observed ∈RC(c). Now if r₃, r₇ and r₁₁ belong to the same RC co-occurrence dependency cluster, one can predict that r₇ and r₁₁ will eventually occur in contract c with some likelihood.

Once co-occurrence cluster have been identified, they can be used to predict other co-occurring risks that may materialize having observed a given risk during post contract-signature (delivery) phase. According to further embodiments of the disclosure, contract profiles, contract similarity and co-occurrence algorithms can be used to create a predictive model that can predict a set of key risks that impact profitability of a new services contract, and predict the overall aggregated risk impact on contract profitability in terms of achieved gross profit (GP) percentage compared to the planned GP percentage. The output of such a predictive model can be used to proactively eliminate predicted target risks defined before contract signing and to generate other risk assessment and mitigation insights.

System Implementations

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system”. Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

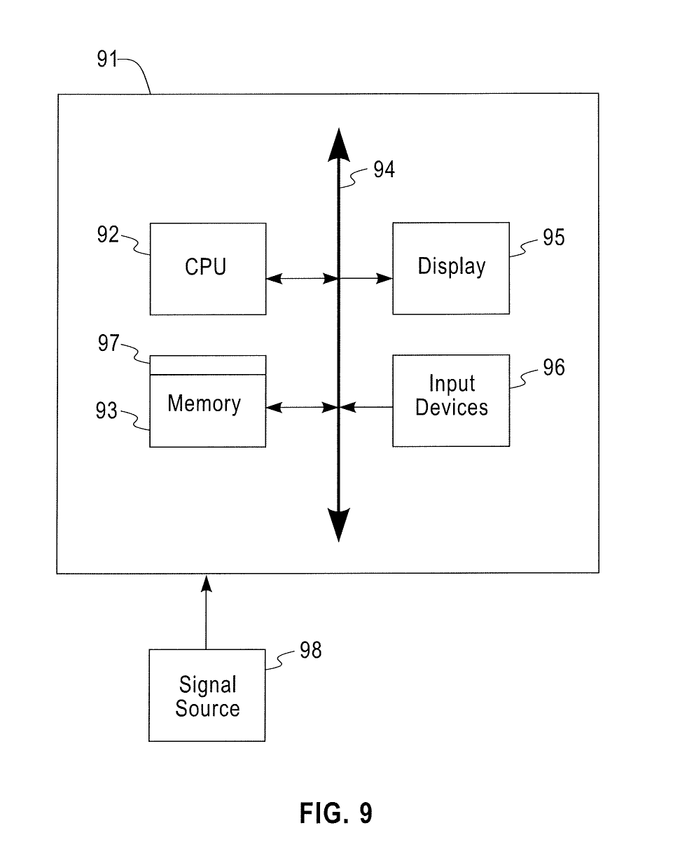

FIG. 9 is a block diagram of an exemplary computer system for implementing a method for predicting contract erosion and renewal risk ahead of contract expiration. Referring now to FIG. 9, a computer system 91 for implementing the present invention can comprise, inter alia, a central processing unit (CPU) 92, a memory 93 and an input/output (I/O) interface 94. The computer system 91 is generally coupled through the I/O interface 94 to a display 95 and various input devices 96 such as a mouse and a keyboard. The support circuits can include circuits such as cache, power supplies, clock circuits, and a communication bus. The memory 93 can include random access memory (RAM), read only memory (ROM), disk drive, tape drive, etc., or a combinations thereof. The present invention can be implemented as a routine 97 that is stored in memory 93 and executed by the CPU 92 to process the signal from the signal source 98. As such, the computer system 91 is a general purpose computer system that becomes a specific purpose computer system when executing the routine 97 of the present invention.

The computer system 91 also includes an operating system and micro instruction code. The various processes and functions described herein can either be part of the micro instruction code or part of the application program (or combination thereof) which is executed via the operating system. In addition, various other peripheral devices can be connected to the computer platform such as an additional data storage device and a printing device.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the present invention has been described in detail with reference to exemplary embodiments, those skilled in the art will appreciate that various modifications and substitutions can be made thereto without departing from the spirit and scope of the invention as set forth in the appended claims.

What is claimed is:

1. A computer-implemented method for predicting risks for information technology (IT) service contracts, the method executed by the computer comprising the steps of:
calculating a probability of occurrence of each of one or more target risks in a target contract;
constructing one or more clusters of root causes observed in historical contracts similar to the target contract, wherein two root causes are in the same cluster if both root causes occur in one or more contracts in said set of historical contracts, wherein two root causes co-occur if both root causes are in the same cluster;
for each of the one or more clusters, identifying root causes that co-occur with one or more target contract risks by searching each said cluster for root causes of similar historical contract risks such that the identified root causes represent additional new contract risks; and
calculating the probability of occurrence of each new target risk identified for said target contract based on root causes identified in said similar historical contract risks.

2. The method of claim 1, wherein calculating a probability of occurrence of each of said one or more target risks in said target contract further comprises:
calculating a similarity between the target contract and each historical contract; and
for each historical contract whose similarity with the target contract is above a similarity threshold, and for each risk associated with the target contract, summing the similarity for each historical contract in which said risk occurs, and dividing by a sum of the similarities of all historical contracts in the set of similar historical contracts.

3. The method of claim 1, wherein constructing one or more clusters of root causes of the one or more target contract risks further comprises:
constructing a graph of the root causes for the one or more target contract risks, wherein two root causes are connected by an edge if the two root causes frequently co-occur in the set of similar historical contracts, wherein the two root causes are defined to frequently co-occur if each of said two root causes occurs for a same subset of the set of similar historical contracts, and a size of the subset with respect to the size of the set of similar historical contracts is greater than a predetermined threshold; and
forming root cause co-occurrence clusters from said graph.

4. The method of claim 3, wherein forming root cause co-occurrence clusters from said graph further comprises:
computing a Laplacian matrix L∈ [symbol] ^{n×n} of said graph, wherein n is a number of root causes;
computing a first k eigenvalues of the Laplacian matrix, wherein k<n;
computing a reduced dimensional matrix T∈ [symbol] ^{n×k} from the predetermined number of eigenvalues;
clustering points (yᵢ), i=1, . . . , n, that correspond to rows of the reduced dimensional matrix into k clusters Cᵢ; and
generating co-occurrence clusters Sᵢ, i=1, . . . , k, from the point clusters wherein Sᵢ={j|yⱼ∈Cᵢ}.

5. The method of claim 4, further comprising using a k-means algorithm to cluster points (yᵢ), i=1, . . . , n, into k clusters Cᵢ.

6. The method of claim 2, wherein calculating the probability of occurrence of each new target risk further comprises calculating a weighted average of a number of occurrences of each new target risk across historical contracts whose similarity may or may not exceed the said similarity threshold, wherein a weight is determined by the contract similarity.

7. The method of claim 1, further comprising adjusting the probability of occurrence of each target risk identified for said target contract based on additional root causes identified through co-occurrence clusters in said similar historical contract risks by adding an adjustment weight to said occurrence probability.

8. The method of claim 7, wherein the adjustment weight for each target risk based on root causes identified through co-occurrence clusters in said similar historical contract risks is calculated based on business logic.

9. The method of claim 7, wherein the adjustment weight for each target risk based on root causes identified though co-occurrence clusters in said similar historical contract risks is calculated by multiplying the occurrence probabilities of each target risk in a chain of target risks, wherein each successive target risk in said chain is dependent upon a preceding target risk in said chain.

10. The method of claim 1, further comprising predicting a set of risks that impact profitability of a new services contract from the one or more target risks in the target contract and the new target risk identified in said similar historical contract risks, and predicting an the overall aggregated risk impact on contract profitability in terms of an achieved gross profit percentage compared to a planned gross profit percentage.

11. The method of claim 1, further comprising eliminating target risks before contract signing.

12. The method of claim 1, further comprising predicting other co-occurring risks based on risks observed during a post contract-signature delivery phase.

13. A non-transitory program storage device readable by a computer, tangibly embodying a program of instructions executed by the computer to perform the method steps for predicting risks for information technology (IT) service contracts, the method comprising the steps of:
calculating a probability of occurrence of each of one or more target risks in a target contract;
constructing one or more clusters of root causes observed in historical contracts similar to the target contract, wherein two root causes are in the same cluster if both root causes occur in one or more contracts in said set of historical contracts, wherein two root causes co-occur if both root causes are in the same cluster;
for each of the one or more clusters, identifying root causes that co-occur with one or more target contract risks by searching each said cluster for root causes of similar historical contract risks such that the identified root causes represent additional new contract risks; and
calculating the probability of occurrence of each new target risk identified for said target contract based on root causes identified in said similar historical contract risks.

14. The computer readable program storage device of claim 13, wherein calculating a probability of occurrence of each of said one or more target risks in said target contract further comprises:
calculating a similarity between the target contract and each historical contract; and
for each historical contract whose similarity with the target contract is above a similarity threshold, and for each risk associated with the target contract, summing the similarity for each historical contract in which said risk occurs, and dividing by a sum of the similarities of all historical contracts in the set of similar historical contracts.

15. The computer readable program storage device of claim 13, wherein constructing one or more clusters of root causes of the one or more target contract risks further comprises:
constructing a graph of the root causes for the one or more target contract risks, wherein two root causes are connected by an edge if the two root causes frequently co-occur in the set of similar historical contracts, wherein the two root causes are defined to frequently co-occur if each of said two root causes occurs for a same subset of the set of similar historical contracts, and a size of the subset with respect to the size of the set of similar historical contracts is greater than a predetermined threshold; and
forming root cause co-occurrence clusters from said graph.

16. The computer readable program storage device of claim 15, wherein forming root cause co-occurrence clusters from said graph further comprises:
computing a Laplacian matrix L∈ [symbol] ^{n×n} of said graph, wherein n is a number of root causes;
computing a first k eigenvalues of the Laplacian matrix, wherein k<n;
computing a reduced dimensional matrix T∈ [symbol] ^{n×k} from the predetermined number of eigenvalues;
clustering points (yᵢ), i=1, . . . , n, that correspond to rows of the reduced dimensional matrix into k clusters Cᵢ; and
generating co-occurrence clusters Sᵢ, i=1, . . . , k, from the point clusters wherein Sᵢ={j|yⱼ∈Cᵢ}.

17. The computer readable program storage device of claim 16, the method further comprising using a k-means algorithm to cluster points (yᵢ), 1=1, . . . , n, into k clusters Cᵢ.

18. The computer readable program storage device of claim 14, wherein calculating the probability of occurrence of each new target risk further comprises calculating a weighted average of a number of occurrences of each new target risk across historical contracts whose similarity may or may not exceed the said similarity threshold, wherein a weight is determined by the contract similarity.

19. The computer readable program storage device of claim 13, the method further comprising adjusting the probability of occurrence of each target risk identified for said target contract based on additional root causes identified through co-occurrence clusters in said similar historical contract risks by adding an adjustment weight to said occurrence probability.

20. The computer readable program storage device of claim 19, wherein the adjustment weight for each target risk based on root causes identified through co-occurrence clusters in said similar historical contract risks is calculated based on business logic.

21. The computer readable program storage device of claim 19, wherein the adjustment weight for each target risk based on root causes identified though co-occurrence clusters in said similar historical contract risks is calculated by multiplying the occurrence probabilities of each target risk in a chain of target risks, wherein each successive target risk in said chain is dependent upon a preceding target risk in said chain.

22. The computer readable program storage device of claim 13, the method further comprising predicting a set of risks that impact profitability of a new services contract from the one or more target risks in the target contract and the new target risk identified in said similar historical contract risks, and predicting an the overall aggregated risk impact on contract profitability in terms of an achieved gross profit percentage compared to a planned gross profit percentage.

23. The computer readable program storage device of claim 13, the method further comprising eliminating target risks before contract signing.

24. The computer readable program storage device of claim 13, the method further comprising predicting other co-occurring risks based on risks observed during a post contract-signature delivery phase.
